(19) United States
(12) Patent Application Publication
(10) Pub. No.: US 2023/0324026 A1
(43) Pub. Date: Oct. 12, 2023

(54) LAMPSHADE

(71) Applicant: Shenzhen Yioumai Technology co.,LTD., Shenzhen (CN)

(72) Inventor: Yang HUANG, Shenzhen (CN)

(73) Assignee: Shenzhen Yioumai Technology co.,LTD., Shenzhen (CN)

(21) Appl. No.: 17/746,093

(22) Filed: May 17, 2022

(30) Foreign Application Priority Data
Apr. 7, 2022 (CN) 202220796318.5

(51) Int. Cl. F21V 1/06; F21V 17/18; F21V 17/12

(52) U.S. Cl. CPC F21V 1/06; F21V 17/18; F21V 17/12

(57) ABSTRACT

The present invention relates to the technical field of lamps and discloses a lampshade (10) with simple structure and convenient assembly. The lampshade comprises a cover body (100) and a frame (200). The cover body (100) is configured to be a cube with a hollow structure and openings at both ends, and the cover body (100) is configured to be foldable, wherein at least one fixing component (101) is arranged on adjacent edges of an opening (120) at one end of the cover body (100). The frame (200) is arranged in the opening (120) at one end of the cover body, wherein the frame (200) and the fixing component (101) are detachably arranged.

### CROSS-REFERENCE TO RELATED APPLICATIONS

The application claims priority to Chinese patent application No. 202220796318.5, filed on Apr. 7, 2022, the entire contents of which are incorporated herein by reference.

### TECHNICAL FIELD

The present invention relates to the technical field of a lampshade of a lamp, and more specifically to a lampshade with simple assembly.

### BACKGROUND

At present, a lampshade structure usually comprises a lampshade frame and a shading cover supported on the frame. The lampshade frame comprises an upper frame and a lower frame. When the lampshade is prefabricated, the upper frame and the lower frame are fixed together to from the lampshade frame with a hollow structure, and then the shading cover is sleeved on the lampshade frame to form a lampshade in which the lamp can be placed. However, the lampshade with the above structure will occupy a large container space during transportation, resulting in high costs of logistics link, which is not conducive to the market competitiveness of products.

Therefore, how to optimize the lampshade structure to improve the assembly convenience and reduce the transportation costs has become an urgent technical problem to be solved by those skilled in the art.

### SUMMARY

The technical problem to be solved by the present invention is that, when a lampshade is prefabricated, an upper frame and a lower frame are fixed together to form a lampshade frame with a hollow structure, and then a shading cover is sleeved on the lampshade frame. The lampshade with the above structure will occupy a large container space during transportation, resulting in high cost of logistics link, which is not conducive to the market competitiveness of products. In view of the above-mentioned defects in the prior art, a lampshade with simple structure and convenient assembly is provided.

The technical solution adopted by the present invention to solve the technical problem is to construct which is configured as a cube with a hollow structure and openings at both ends, wherein the cover body is configured to be foldable, at least one fixing component is arranged on adjacent edges of an opening at one end of the cover body, and
a frame, which is arranged in the opening at one end of the cover body, wherein the frame is detachably arranged relative to the fixing component.

In some embodiments, the fixing components are configured as buckle components, and the buckle components are respectively arranged on inner edges of the opening at one end of the cover body,
the frame is embedded into the buckle components and detachably connected with the buckle components.

In some embodiments, the buckle components are configured as metal or plastic buckles with a front opening or a bottom opening.

In some embodiments, the fixing components are configured as hook buckles, which are respectively arranged on the outward-extending inner edges of the opening at one end of the cover body,
multiple loop buckles corresponding to the hook buckles are arranged on insides of an outer border of the frame, so that the frame is detachably arranged on the cover body through a close cooperation between the hook buckles and the loop buckles.

In some embodiments, the frame comprises at least one connecting rod and at least one fixing base,
the connecting rod is connected to a border of the frame, and the fixing base is fixed in the frame through the connecting rod.

In some embodiments, the fixing base is connected to a top plate of the cover body by screws.

In some embodiments, a notch extending along inside of the fixing base is provided on one side of the fixing base.

In some embodiments, the cover body comprises a light-transmitting layer and a fabric layer, the light-transmitting layer is configured as an inner layer of the cover body, and the light-transmitting layer is wrapped by the fabric layer.

In some embodiments, at least one positioning component is arranged on adjacent edges of another opening at the other end of the cover body, and the positioning component is arranged on an upper edge of the another opening at the other end of the cover body.

In some embodiments, a gap is formed between every two positioning components.

The lampshade of the present invention comprises a cover body with a hollow structure and openings at both ends, wherein at least one fixing component is arranged on adjacent edges of an opening at one end of the cover body, a frame is arranged in the opening at one end of the cover body, and the frame and the fixing component are detachably arranged. Compared with the existing technology, at least one fixing component and a frame detachably arranged with the fixing component are arranged on the inner side of the opening at one end of the cover body, so that the convenience of the lampshade assembly is improved. Besides, the cover body can be folded during transportation, which can reduce the volume of the container, thereby reducing the transportation costs.

### BRIEF DESCRIPTION OF DRAWINGS

The present invention will be further described in combination with the accompanying drawings and embodiments, in which:

FIG. 1 is a perspective view of a lampshade according to an Embodiment of the present invention;

FIG. 2 is an exploded view of the lampshade according to an Embodiment of the present invention;

FIG. 3 is a perspective view of the lampshade according to another Embodiment of the present invention;

FIG. 4 is an exploded view of the lampshade according to another Embodiment of the present invention;

FIG. 5 is an enlarged view of a fixing component provided by the present invention;

FIG. 6 is a perspective view of a frame according to an Embodiment of the present invention;

FIG. 7 is a perspective view of the lampshade according to Embodiment 3 of the present invention;

FIG. 8 is an exploded view of the lampshade according to Embodiment 3 of the present invention;

FIG. 9 is an exploded view of the lampshade according to Embodiment 4 of the present invention;

FIG. 10 is a perspective view of the frame according to another Embodiment of the present invention;

FIG. 11 is a partial schematic view of the cover body according to an Embodiment of the present invention;

FIG. 12 is a perspective view of the lampshade according to Embodiment 5 of the present invention.

### DETAILED DESCRIPTION OF THE EMBODIMENTS

In order to have a clearer understanding of the technical features, purposes and effects of the present invention, the specific embodiments of the present invention are described in detail with reference to the accompanying drawings.

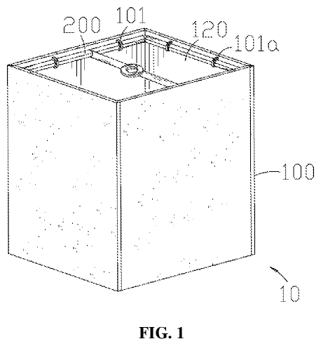

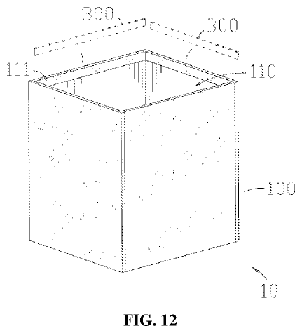

As shown in FIG. 1 and FIG. 12, a lampshade 10 comprises a cover body 100, a frame 200 and at least one positioning component 300 in Embodiment 1 of the present invention.

The cover body 100 is used for protecting and accommodating the lamp, which is configured as a cube or cylinder with a hollow structure and openings at both ends, and is arranged in a regular or irregular shape. The cover body 100 is configured to be foldable, that is, to be stacked or folded in half along its external edges.

Furthermore, at an opening 120 of the cover body 100 corresponding to a bottom side of the lampshade 10, at least one fixing component 101 is arranged on adjacent edges of the opening 120.

Specifically, on the one hand, taking that the cover body 100 is a cube as an example, all the adjacent edges of the opening 120 of the cover body 100 are provided with the fixing components 101, that is, according to any edge, the inner edges on its left and right sides are both provided with the fixing components 101, which can maintain the stability of the frame 200 when the frame 200 is fixed.

On the other hand, taking that the cover body 100 is a cylinder as an example, according to an inner diameter at any point of the opening 120, the inside edges on its left and right sides can be symmetrically provided with the fixing components 101, which can maintain the stability of the frame 200 when the frame 200 is fixed.

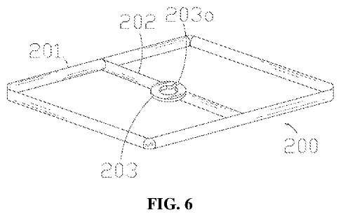

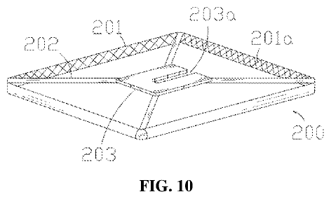

As shown in FIG. 6 and FIG. 10, the frame 200 is used for fixing and supporting the cover body 100 from one end (corresponding to the opening 120) of the cover body 100, which is arranged in a square or circle shape corresponding to the cover body 100 and is configured as a hollow structure.

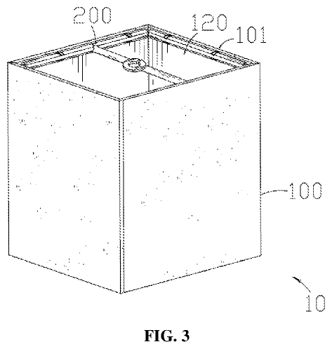

As shown in FIG. 1 to FIG. 4, the frame 200 is arranged in the opening 120 at the end of the cover body 100. When assembling, the frame 200 is screw fixed, embedded, snapped or wrapped in the fixing components 101, so that the frame 200 is detachably arranged relative to the fixing components 101.

By using this technical solution, at least one fixing component 101 and the frame 200 that is detachably arranged relative to the fixing component 101 are arranged on the inner side of the opening 120 at one end of the cover body 100, thereby improving the convenience of the lampshade assembly. Besides, the cover body 100 can be folded after the frame 200 is disassembled, which can reduce the volume of the container during transportation, thereby reducing the transportation costs.

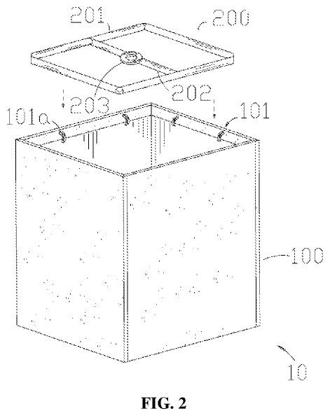

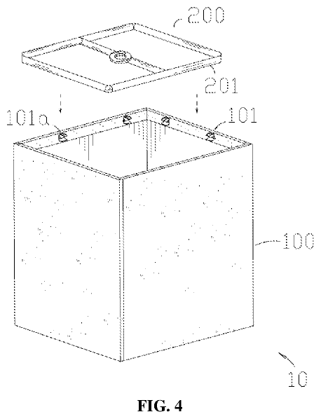

In some embodiments, as shown in FIG. 2 and FIG. 4, in order to improve the cooperation stability between the fixing components 101 and the frame 200, the fixing components 101 can be configured as a buckle components 101a, wherein the buckle components 101a are embedded into the inner side of the opening 120 at one end of the cover body 100 or are arranged integrally with the cover body 100.

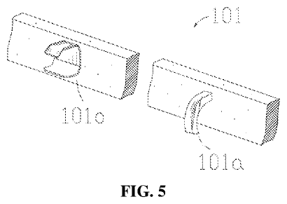

As shown in FIG. 5, the buckle components are configured as metal or plastic buckles with a front opening or a bottom opening, such as manganese steel buckles, copper buckles or iron buckles.

Specifically, as shown in FIG. 1 to FIG. 4, the buckle components 101a are respectively disposed on the inner edges of the opening 120 at one end of the cover body 100. The frame 200 is snapped or embedded into the buckle components 101a when being assembled. The buckle components 101a are interference fit with the frame 200, so that the frame 200 is detachably connected with the buckle components 101a.

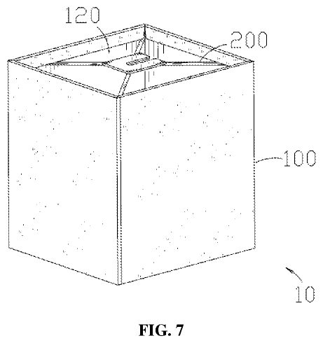

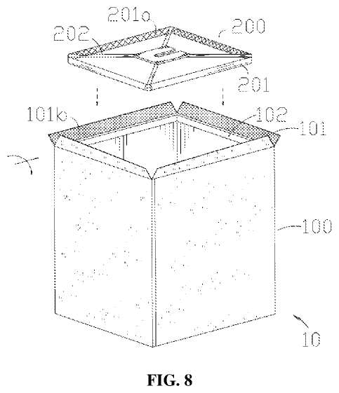

In some embodiments, as shown in FIG. 7 and FIG. 8, in order to improve the cooperation stability of the fixing components 101 and the frame 200, the fixing components 101 can be configured as hook buckles 101b, wherein the hook buckles 101b are respectively arranged on the outward-extending inner edges of the opening 120 at one end of the cover body 100. For example, four inner edges of the opening 120 are all provided with the hook buckles 101b.

Furthermore, multiple loop buckles 201a corresponding to the hook buckles 101b are arranged on the insides of an outer border of the frame 200. When fitting, the hook buckles 101b extending outwardly are fastened inward with respect to the opening 120 to form the overall shape as shown in FIG. 7. With the close cooperation of the hook buckles 101b and the loop buckles 201a, the frame 200 can be detachably arranged on the cover body 100.

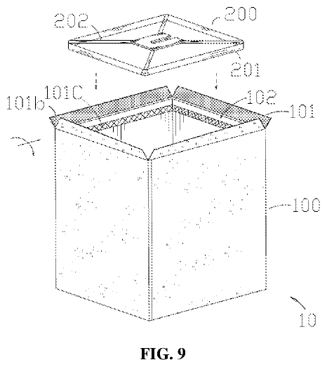

In other embodiments, as shown in FIG. 9, the loop buckles 101c can also be arranged at a lower end of the inner edges of the opening 120, that is, arranged at the lower end of the outer border where the frame 200 is placed (corresponding to the lower edge of the placement position 102 of the frame 200), and the loop buckles 101c is connected with the lower end of the outer border of the frame 200. The frame 200 is detachably arranged on the cover body 100 through the close cooperation of the hook buckles 101b and the loop buckles 101c disposed on the lower end of the outer border of the frame 200.

In some embodiments, as shown in FIG. 6 and FIG. 10, in order to improve the convenience of use, at least one connecting rod 202 and at least one fixing base 203 for placing the lamp (not shown) can be provided in the frame 200. The fixing base 203 can be arranged at the center of the frame 200, or connected with a top plate of the cover body 100 by screws. The connecting rod 202 is connected with the border of the frame 200, and the fixing base 203 is fixed in the frame 200 through the connecting rod 202.

Furthermore, a notch 203a extending along inside of the fixing base 203 is provided on one side of the fixing base 203. The assembled lampshade 10 is placed on a support stand (not shown) with installed lamp, and a wire at one end of the lamp can be embedded into the fixing base 203 along the notch 203a of the fixing base 203, so that the lamp can be placed on the fixing base 203 easily, thereby improving the convenience of use.

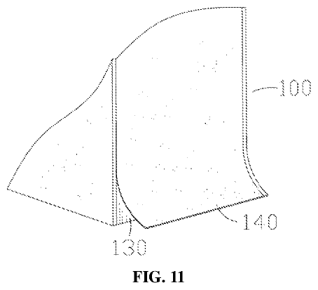

In some embodiments, as shown in FIG. 11, in order to improve the use experience of the cover body 100, the cover body 100 can be configured as comprising a light-transmitting layer 130 and a fabric layer 140, wherein the light-transmitting layer 130 is arranged as an inner layer of the cover body 100, and the light-transmitting layer 130 is wrapped by the fabric layer 140. When in use, the lamp in the lampshade 10 is turned on, and light can pass through the light-transmitting layer 130 and the fabric layer 140 to illuminate the room.

In some embodiments, as shown in FIG. 12, in order to improve the use performance of the cover body 100, at least one positioning component 300 can be arranged on adjacent edges of another opening 110 at the other end of the cover body 100, and the positioning components 300 are arranged on an upper edge 111 of the another opening 110 at the other end of the cover body 100. The cover body 100 positions the openings at both ends of the cover body 100 through the cooperation of the positioning components 300 and the frame 200.

A gap is formed between every two positioning components 300, and the gap is set as 0.7-1.3 cm, so that the cover body 100 can be folded along its external edges.

It should be noted that the another opening 110 of the cover body 100 is at the top of the lampshade 10.

The embodiments of the present invention have been described above in conjunction with the accompanying drawings, but the present invention is not limited to the above-mentioned specific embodiments, which are merely indicative rather than restrictive. Under the inspiration of the present invention, many forms can also be made by those skilled in the art without departing from the scope protected by the purposes and claims of the present invention, and all these are within the protection scope of the present invention.

1. A lampshade, comprising:
a cover body (100), which is configured as a cube with a hollow structure and openings at both ends, wherein the cover body (100) is configured to be foldable, at least one fixing component (101) is arranged on adjacent edges of an opening (120) at one end of the cover body (100), and
a frame (200), which is arranged in the opening (120) at one end of the cover body (100), wherein the frame (200) is detachably arranged relative to the fixing component (101), a fixing base (203) provided in the frame and a notch (203a) extending along inside of the fixing base (203) is provided on one side of the fixing base (203).

2. The lampshade according to claim 1, wherein the fixing components (101) are configured as buckle components (101a), and the buckle components (101a) are respectively arranged on inner edges of the opening (120) at one end of the cover body (100),
the frame (200) is embedded into the buckle components (101a) and detachably connected with the buckle components (101a).

3. The lampshade according to claim 2, wherein the buckle components (101a) are configured as metal or plastic buckles with a front opening or a bottom opening.

4. The lampshade according to claim 1, wherein the fixing components (101) are configured as hook buckles (101b), which are respectively arranged on the outward-extending inner edges of the opening (120) at one end of the cover body (100),
multiple loop buckles (201a) corresponding to the hook buckles (101b) are arranged on insides of an outer border of the frame (200), so that the frame (200) is detachably arranged on the cover body (100) through a close cooperation between the hook buckles (101b) and the loop buckles (201a).

5. The lampshade according to claim 1, wherein the frame (200) comprises at least one connecting rod (202) and at least one fixing base (203),
the connecting rod (202) is connected to a border of the frame (200), and the fixing base (203) is fixed in the frame (200) through the connecting rod (202).

6. (canceled)

7. (canceled)

8. The lampshade according to claim 1, wherein the cover body (100) comprises a light-transmitting layer (130) and a fabric layer (140), the light-transmitting layer (130) is configured as an inner layer of the cover body (100), and the light-transmitting layer (130) is wrapped by the fabric layer (140).

9. The lampshade according to claim 1, wherein at least one positioning component (300) is arranged on adjacent edges of another opening (110) at the other end of the cover body (100), and the positioning component (300) is arranged on an upper edge of the another opening (110) at the other end of the cover body (100).

10. The lampshade according to claim 9, wherein a gap is formed between every two positioning components (300).
